(19) United States
(12) Patent Application Publication
(10) Pub. No.: US 2004/0069705 A1
(43) Pub. Date: Apr. 15, 2004

(54) Long free vortex, multi-compartment separation chamber cyclone apparatus

(76) Inventors: Wlodzimierz Jon Tuszko, Camarillo, CA (US); Wojciech Tuszko, Santa Monica, CA (US)

Correspondence Address: Wlodzimierz J. Tuszko, 5434 Camino De Ville, Camarillo, CA, 93012, US

(21) Appl. No.: 10/623,326

(22) Filed: Jul. 19, 2003

Related U.S. Application Data
(63) Continuation-in-part of application No. 10/131,425, filed on May 22, 2002, now Pat. No. 6,596,170.

(51) Int. Cl. B03C 3/00

(52) U.S. Cl. 210/512.1

(57) ABSTRACT

The long-free vortex multi-compartment separation chamber cyclone apparatus features of the decreased pressure drop increase both capacity and separation efficiency as well as of ability to be adjusted to the solid particles distribution of the feed processor.

This Application is of Continuation in Part Application to the application Ser. No. 10/131425 dated Apr. 23, 2002 when its U.S. Pat. No. 6,596,170 will be issued on Jul. 22, 2002 now abandoned.

This invention relates to an apparatus for continuous separation of solid-solid, solid-fluid suspension of particulate material. More specifically, the invention is directed to considerably increasing capacity and separation efficiency as well as to reduce pressure drop compared to the conventional conical cyclone separator.

### BACKGROUND

An early hydrocyclone method and apparatus from U.S. Pat. No. 453,105 (Bretney) issued May 28, 1891 in which there were two stages, in line, in the separating hydrocyclone. A frequent problem with this and later hydrocyclone devices are—so called “back mix,” high pressure drop and fast erosion of the conical portion.

A hydrocyclone is a device for creation of a free vortex, and it is the vortex that does the work in separating the particle matter form liquid.

The new features of the hydrocyclone air core as the vortex driving force, was discovered and used to greatly improve the hydrocyclone collectors, Wlodzimierz J. Tuszko and all U.S. Pat. No. 4,927,298 issued May 22, 1990. U.S. Pat. No. 5,269,949 issued Dec. 14, 1993, U.S. Pat. No. 5,273,647 issued Dec. 28, 1993, application Ser. No. 08/238,903 filing date May 6, 1994 now abandoned. application Ser. No. 08/402,175 filing date Mar. 10, 1955 now abandoned. U.S. Pat. No. 6,071,424 issued Jun. 6, 2000, application Ser. No. 10/131425 filed Apr. 23, 2002

It is the U.S. Pat. No. 6,071,424 and application Ser. No. 10/131425 filed Apr. 23, 2002 that generated the idea of multi-compartment separation chamber cyclone. This idea is absolutely unique from time when first Bretney's cyclone was patented. Thus, the idea of multi-compartment cyclone apparatus is obvious the intellectual property of the inventor of this U.S. Pat. No. 6,071,424.

Therefore, the object of the present invention is to prevent the U.S. Pat. No. 6,071,424 and patent application Ser. No. 10/131425 from infringement with claim elements omitted in these documents.

### SUMMARY OF THE INVENTION

This invention relates to a device for separating of particulate fluid suspension known as a cyclone separator, in which centrifugal forces of the revolving particulate suspension cause separation of the suspension into finer and coarser or light and denser fractions. The conventional of the conical predominating shape, cyclone features of both high pressure drop and energy consumption to get a low separation efficiency for low capacity. This conical cyclone portion participates in creating so-called “back mix” and is vulnerable to be fast eroded.

To avoid those harmful phenomenons the present invention provides long-free vortex multi-compartment separation chamber cyclone with air core or without it.

### BRIEF DESCRIPTION OF THE DRAWING

FIG. 1 is a view of the one compartment separation chamber conventional conical cyclone.

FIG. 2 is a cross-section view of FIG. 1.

FIG. 3 is a view of plurality of cylindrical telescopic units to create multi-compartment separation chamber in cylindrical telescopic cylone housing as Embodiment1.

FIG. 4 is a view of plurality of cylindrical telescopic units to create one compartment separation chamber in cylindrical telescopic cyclone housing as Embodiment2.

FIG. 5 is a view of plurality of cylindrical telescopic units to create multi-compartment separation chamber in conical cyclone housing as Embodiment3.

### DETAILED DESCRIPTION OF THE INVENTION

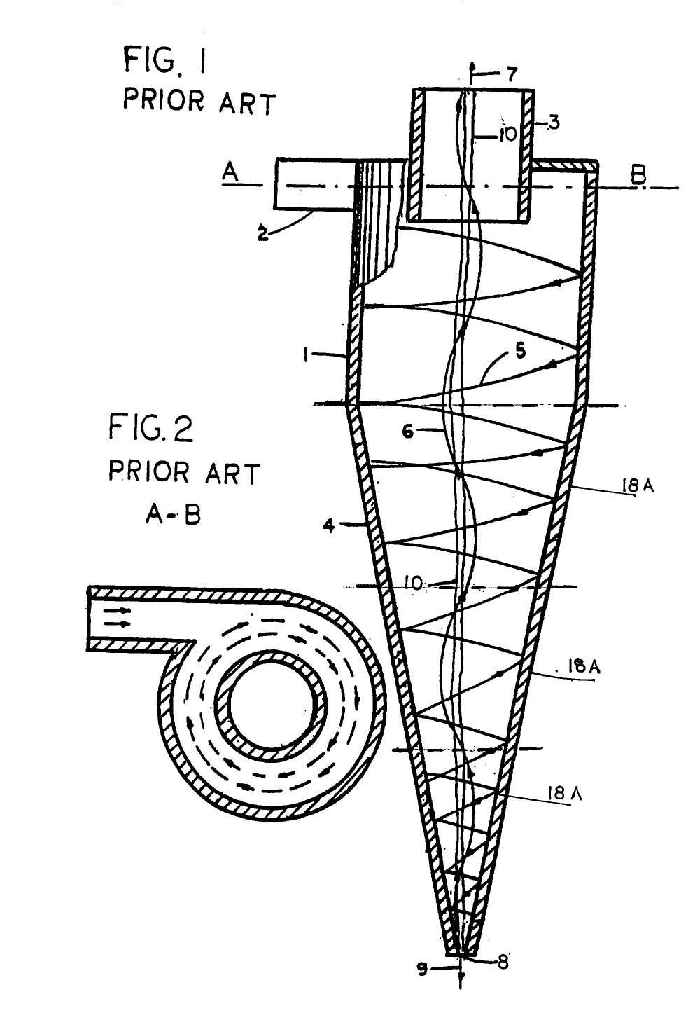

A conventional conical cyclone for separating of fluid mixtures which are centrifugally separable is illustrated in FIG. 1 and FIG. 2. This cyclone is comprised of short cyclindrical portion 1 having an inlet duct 2 for introduction of a feed suspension or feed mixture in tangential direction. An exhaust or overflow pipe 3 extends through the top or ceiling wall of the cylindrical portion 1. A frustum-conical portion 4 is axially aligned with the exhaust pipe 3. In the portion 1 and 4 together as in separating chamber the feed suspension of feed mixture flows in the helical swirling flow pattern so to establish counter-flowing outer 5 and inner 6 vortexes within the separating chamber inherently causing solids in the fluid flow, which are smaller or lighter to move to the inner vortex 6 and exist through overflow pipe 3 as a smaller or lighter product stream or overflow 7. Ingredients in the fluid flow which are coarser or heavier move to the outer vortex 5 and exit through the outlet 8 as a coarser or heavier product stream or as underflow 9. Along the central hydrocyclone vertical axis to the air core 10 is created, that extends from underflow outlet 8 throughout all long conical portion 4 cylindrical portion 1, and finally through the exhaust pipe 3.

The fundamental unit 16 of the new invented multi-compartment separation chamber comprises of two different diameter cylinders 12a and 12b axially connected with passage 13 that can be of the same material as cyclone housing or is of replaceable liners. The plurality of those fundamental units when put together axially creates multi-compartment separation chamber, so that each compartment can be seen as a separate cyclone. This multi-compartment separation chamber can be designed in cylindrical telescopic cyclone housing or in another kind of housing; for example, in a conical one.

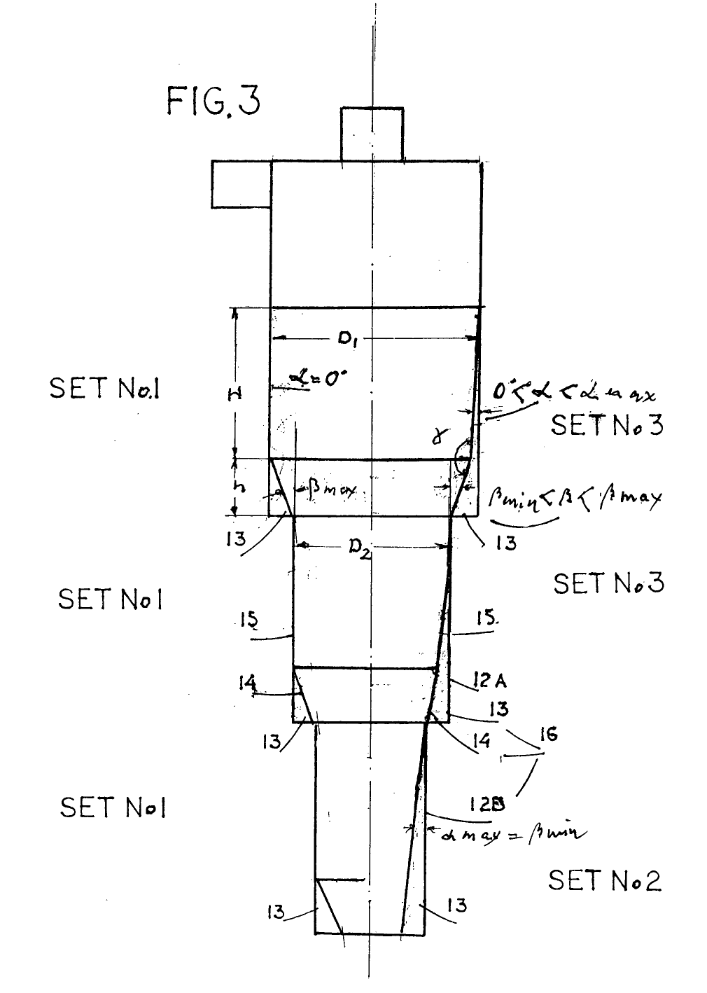

In FIG. 3 is shown a plurality of cylindrical telescopic unit when multi-compartment separation chamber is designed in cylindrical telescopic cyclone housing as Embodiment1.

Further, the longitude axial wall section of fundamental unit is formed by two stretches—upper one 15 and lower one 14. The upper stretch 15 creates with longitude cyclone axis the angle. The lower stretch 14 creates with cyclone longitude axis the angle. The inside angle between stretches 14 and 15 is the angle.

$$tg {α}_{max} = \frac{{D}_{1} - {D}_{2}}{2 ( H + h )}$$

$$tg {β}_{max} = \frac{{D}_{1} - {D}_{2}}{2 h}$$

$$tg {α}_{max} = tg {β}_{min}$$

If a given dimensions of the two cylinders and the passage are as follows: H+h—total heights of upper cylinder

h—height of passage

D1—diameter of upper cylinder

D2—diameter of lower cylinder

then the angles whole change extent is

For situation of the angle Set No. 1 when and the unit consists of the predominanting upper cylindrical portion and of lower conical portion. Then, the best cyclone performances are to be achieved.

For situation of the angle Set No. 2 when and the unit is of one whole conical shape. Then, the worse cyclone performances are to be achieved.

For situation of the angle Set. No. 3, being between Set. No. 1 and Set No. 2 when the unit consists of two conical portions upper one and lower one. The cyclone performances are gradually worsening after the angle is growing.

In general case, the dimensions of all given multi-compartment separation chamber units can differ each other.

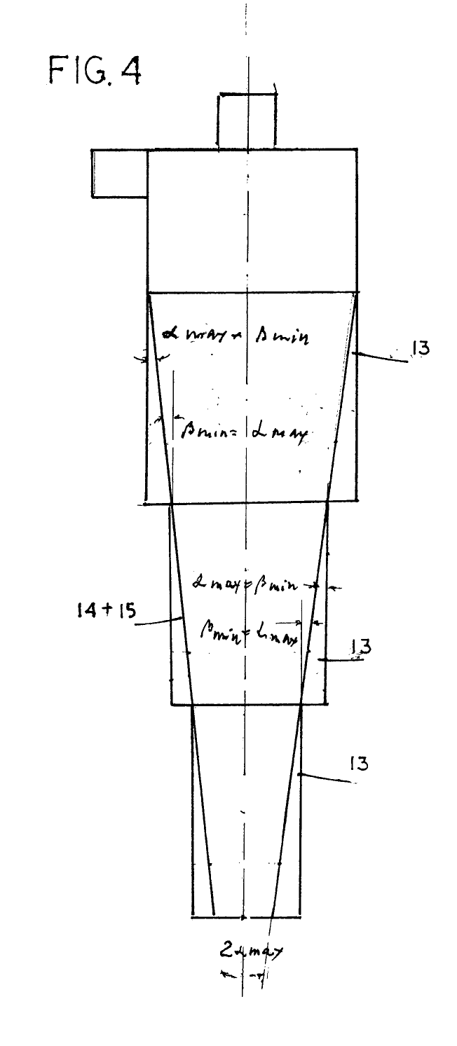

In FIG. 4 is shown Embodiment2 as particular case of Embodiment1. All units are of the same height dimensions and the same angle is used for each unit. Then the multi-unit separation chamber cylindrical telescopic housing becomes one conical compartment.

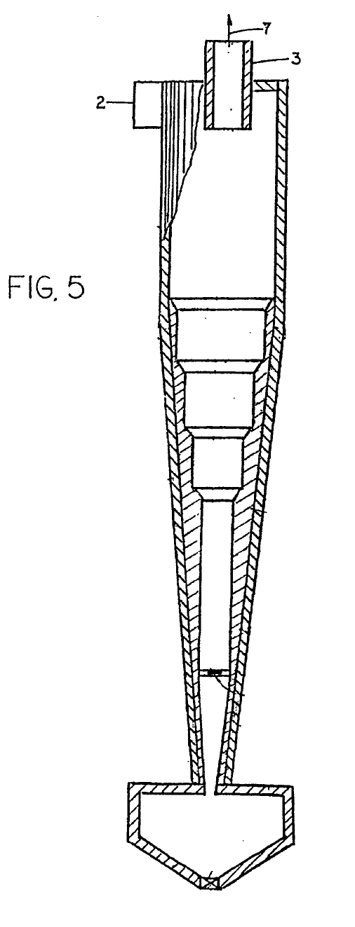

In FIG. 5 is shown the Embodiment3 when the multi-compartment separation chamber is designed as a replaceable liners put in conical housing.

The invention is not to be limited by the embodiment shown in the drawings or description in the specification which is given by way of example and not limitation, but only in accordance with scope of the appended claim.

I claim:

1. In the cyclone apparatus, feed fluid comprising solid-solid, solid-fluid particulate suspension delivered in fluid flow to a cyclone separator, having an axially elongated cylindrical conical separation chamber, a cylindrical upper portion and conical bottom portion the said cylindrical upper portion having an exhaust pipe, having a bottom region disposed in said upper portion of said separation chamber and an inlet duct disposed in said upper portion of said separation chamber for introducing said feed fluid in a tangential direction in a helical swirling flowing pattern so as to establish a circular velocity and counter-flowing inner and outer vortexes within the cylindrical-conical separating chamber, a lighter portion of said feed fluid moves to the inner vortex and exits through the exhaust pipe as overflow and to a heavier portion of said feed fluid moves to the outer vortex and exist through the bottom outlet, as underflow, the improvement in the apparatus comprising the step of.:
Introducing a plurality of fundamental cylindircal telescopic units to create multi-compartment separation chamber so that each compartment can be seen as separated cyclone. All those according the idea generated in U.S. Pat. No. 6,071,424 and application Ser. No. 10/131425 filed Apr. 23, 2002.

2. The improved apparatus according to claim 1 introducing multi-compartment separation chamber so it can be designed in cylindrical telescopic cyclone housing as well as in conical cyclone housing.

3. The improved apparatus according to claim 1 introducing the fundamental telescopic unit comprising two different dimensions cylinders axially connected with passage between them made of the same material like cyclone housing or as replaceable liners.

4. The improved apparatus according to claim 1 introducing the longitude axial wall section of the fundamental unit comprising the angle between upper wall stretch and longitude axis, the angle between lower wall stretch and longitude axis, and the interior angle between upper and lower stretches.

5. The improved apparatus according to claim 1 as Embodiment1 introducing for a given fundamental unit measurements comprising such Set. No.1 of angle so that the unit upper portion is predominately cylindrical and lower portion is conical Then to obtain the best cyclone performances.

6. The improved apparatus according to claim 1 as Embodiment2 introducing for a given fundamental unit measurements comprising the Set No.2 of angles that the unit is of all long one conical shape to obtain the worse cyclone performances.

7. The improved apparatus according to claim 1 as Embodiment1 introducing for a given fundamental unit measurement comprising such Set No.3 of the angle to be between Set No.1 and Set No.2, that the unit consists of two conical portions, upper one and lower one. Then the decreased cyclone performances follow growing the angle.

8. The improved apparatus according to claim 5, 6 and 7 introducing the suitable replacable liners to be put in cyclone housing to get the chosen shape of each compartment, if cyclone housing is not formed finally as desired to get the cylindrical telescopic multi-compartment separation chamber.
